(19) United States
(12) Patent Application Publication
(10) Pub. No.: US 2007/0194099 A1
(43) Pub. Date: Aug. 23, 2007

(54) SYSTEM AND METHOD FOR TRACKING PEOPLE AFFECTED BY A PUBLIC HEALTH CRISIS AND A TAG FOR USE THEREWITH

(76) Inventors: Russell L. Miller, Traverse City, MI (US); Michael A. Whelan, Traverse City, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/673,362

(22) Filed: Feb. 9, 2007

Related U.S. Application Data
(60) Provisional application No. 60/771,756, filed on Feb. 9, 2006.

(51) Int. Cl. G06F 17/00; G08B 13/14; G08B 1/08; G08B 23/00

(52) U.S. Cl. 235/375; 340/572.1; 340/573.1; 340/539.13

(57) ABSTRACT

A system and method for tracking people affected by a public health crisis, including a plurality of tags having a first portion, a second portion, at least one removable barcode, and an external database. A single tag of the plurality of tags is associated with a person. The first portion provides at least triage information. The second portion provides at least evacuee information. The at least one removable barcode is placed on the at least one other person's tag to indicate relationship information between the person and the at least one other person. At least one of the triage information, the evacuee information, and the relationship information are transmitted from the tag and stored in the external database.

### CROSS-REFERENCE TO RELATED APPLICATION

This application claims the benefit under 35 U.S.C. § 119(e) of U.S. Provisional Patent Application No. 60/771,756, entitled “SYSTEM AND METHOD FOR TRACKING PEOPLE AFFECTED BY A PUBLIC HEALTH CRISIS AND A TAG FOR USE THEREWITH,” filed on Feb. 9, 2006, the entire disclosure of which is incorporated herein by reference.

### FIELD OF THE INVENTION

The present invention generally relates to a system and method of tracking people in a public health crisis and a tag for use therewith.

### BACKGROUND OF THE INVENTION

A public health crisis may arise from a natural disaster (i.e., hurricane, tornado, earthquake, flood, etc.), emergency situations (i.e., hazardous material spills, fires, traffic accidents, plane crashes, etc.), or from terrorist activity. Such a public health crisis may involve a mass casualty incident. A public health crisis represents a major logistical challenge for emergency response personnel who must locate, triage, treat, stage, transport, and deliver numerous victims to medical facilities or a morgue. Time is of the essence in the ability to ascertain the identification, status, and medical condition of the victims. During the emergency, disaster, or incident, traditional data/communication field systems (such as telephone, cellular, RF transmissions, etc.) could be “down” or overloaded, suggesting the prudence of having an alternative or supplementary method of data communication.

During mass casualty incidents, triage tags are used to indicate the triage status of victims. These tags are attached to the victim and typically have a color and/or number coding to indicate the seriousness of the injury (i.e. Black/0=dead; Red/1=Immediate; Yellow/2=Delayed; Green/3=Minor). As disclosed in commonly owned U.S. Pat. No. 6,761,312, triage tags may also have a barcode to uniquely identify the victim with a serial number. Historically, these tags have not addressed the need to track evacuees in general or at-risk civilians during a public health crisis requiring Mass Prophylaxis and possible quarantine.

Therefore, it is desirable to develop a system and method for tracking people during a public health crisis where the information about the person is on a tag assigned to the person. Additionally, it is desirable to develop a system and method where at least a portion of the information on the person's tag is stored in an external database so that a person's medical condition, evacuee status, and/or relationship information can be searched.

### SUMMARY OF THE INVENTION

According to one embodiment of the present invention, a tracking system comprises a plurality of tags where a single tag is associated with a person. The tag has a first portion, a second portion, at least one removable barcode, and an external database. The first portion provides at least triage information. The second portion provides at least evacuee information. The at least one removable barcode is placed on the at least one other person's tag to indicate relationship information between the person and the at least one other person. At least one of the triage information, the evacuee information, and the relationship information are transmitted from the tag and stored in the external database.

According to another embodiment of the present invention, a tag is associated with a person comprising a first portion, a second portion, and a removable barcode. The first portion includes a plurality of areas for providing at least triage information pertaining to the person's medical condition. The second portion includes a plurality of areas for providing evacuee information pertaining to at least the person's evacuee status. The removable barcode is placed on another person's tag to indicate a relationship between the persons.

According to yet another embodiment of the present invention, a method of tracking a person or pet affected by a public health crisis, where the method comprises the steps of locating a person or pet and assigning a tag to the person or pet. At least one of the triage information, evacuee information, and relationship information associated with the person or pet is determined. The desired triage information, evacuee information, and relationship information are placed on the tag. At least a portion of the person's or pet's triage, evacuee, and relationship information is stored on an external database.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1A is a front side of a first portion of a tag constructed in accordance with one embodiment of the present invention;

FIG. 1B is a back side of a second portion of the tag shown in FIG. 1A in accordance with one embodiment of the present invention;

FIG. 1C is a front side of a second portion of a tag constructed in accordance with one embodiment of the present invention;

FIG. 1D is a back side of the second portion of the tag shown in FIG. 1C in accordance with one embodiment of the present invention;

FIG. 2 is a system diagram in block form of a system constructed in accordance with one embodiment of the present invention;

FIG. 3 is a flow chart illustrating a general flow of operations utilizing portable data in accordance with one embodiment of the present invention; and

FIG. 4 is a flow chart of a method for tracking people in a public health crisis in accordance with one embodiment of the present invention.

### DETAILED DESCRIPTION OF THE PREFERRED EMBODIMENT

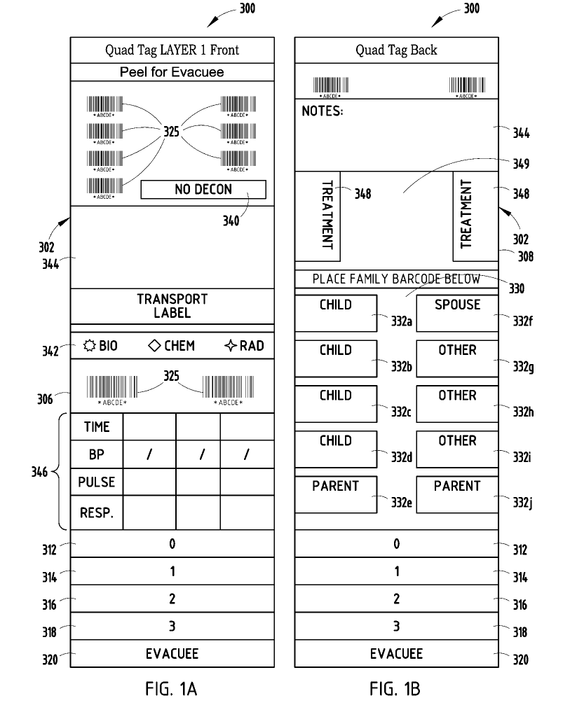

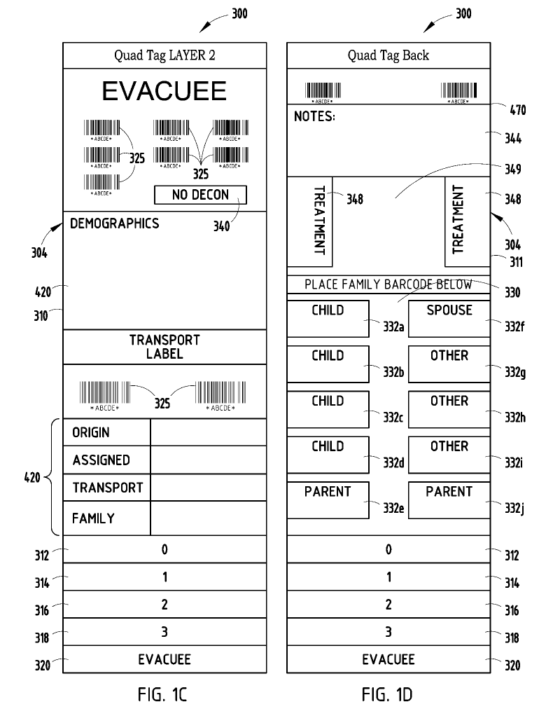

As mentioned above and explained in more detail below, the present invention generally relates to a system and method for tracking people affected by a public health crisis and, more generally, for maintaining information pertaining to such people. Typically, a plurality of tags are provided, where a single tag is associated with each person and contain certain information. An example of such a tag is generally shown at 300 in FIGS. 1A-1D. Typically, the tag 300 has a first portion generally indicated at 302 and a second portion generally indicated at 304. The first portion 302 can have a front side 306 and a back side 308, and the second portion 304 can have a front side 310 and a back side 311. As described in greater detail below, the back side 308 and back side 311 can be the same such that the first portion 302 is removed or peeled off to make the front side 310 of the second portion 302 accessible. The tag 300 provides a plurality of areas wherein information, such as, but not limited to, triage information, evacuee information, relationship information, personal information, decontamination information, and the like, can be placed on the tag 300. Typically, the front side 306 of first portion 302 includes the triage information, the front side 310 of second portion 304 includes the evacuee information, and the back sides 308,311 include the relationship information.

The tag 300 comprises a plurality of tabs having a predetermined classification for indicating the triage or evacuee status of the person. By way of explanation and not limitation, the tabs can include priority numbers and/or color classifications for identifying the status of the person. Such tabs can be, but are not limited to; a tab 320 that is blue, and indicates that the person is an evacuee rather than a casualty; a black tab 312 labeled with triage priority number “0,” meaning the person is dead; a red tab 314 labeled with triage priority number “1,” meaning the person is in need of immediate medical attention; a yellow tab 316 labeled with triage priority number “2,” meaning the person is in need of delayed medical care; and a green tab 318 labeled with triage priority number “3,” meaning the person has minor injuries. Typically, the tabs 312,314,316,318,320 are torn off the tag 300 to indicate the status of the person.

In addition, the tag 300 may include peel-off barcode stickers or removable barcodes 325. Typically, the removable barcodes 325 have a unique serial number. The removable barcodes 325 can be removed and affixed to tags 300 of another person, such as, but not limited to, a relative or related family member. Also, the plurality of areas of tag 300 may include an area 330 where the similar removable barcode 325 of related family members' tags 300 may be secured. By way of explanation and not limitation, area 330 may have certain regions or squares 332a-332j designated for certain types of relations such as, but not limited to, “child, “parent,” “spouse,” “other,” or the like, which are used in order to determine the relationship information of the person.

For example, and in no way limiting, a mother's removable barcode 325 would be removed from her tag 300 and attached to her child's tag 300 in region 332e of area 330 and, conversely, the child's removable barcode 325 would be removed and attached to the mother's tag 300 in one of regions 332a-332d of area 330. The unique serial number of the removable barcode 325, which is used to determine the relationship information of the person, is typically transmitted and stored in an external database, such as computer hardware system 20, as described in greater detail below. Thus, if related family members are separated, or if family members need to be notified, a serial number search can be conducted against an external database as information of other people is processed throughout the incident of crisis, as described in greater detail below. So, for instance, if the child becomes separated from the mother, the child's tag 300 can be used to find the mother—by scanning the mother's removable barcode 325 and conducting a search on the external database or computer hardware system 20 for the last known location. Another example of using the removable barcode 325 would be to notify family members of a death, the manner by which is described in U.S. Pat. No. 6,761,312, entitled “SYSTEM AND METHOD FOR TRACKING VICTIMS OF A MASS CASUALTY INCIDENT,” which is hereby incorporated herein by reference.

Typically, the tags 300 are designed to be used as either a triage tag or an evacuee tag. If the person is not a casualty, but instead is an evacuee, the first portion 302 can be peeled off or removed to access the evacuee information on the second portion 304. This allows the user groups to cross-utilize the tags 300—so they can go to the field with just one roll or stack of label stock providing major efficiencies. As set forth above, if the first portion 302 is peel-off, the back sides 308,311 are the same, such that the back sides 308,311 are used when either the first portion 302 or second portion 304 is used. However, if the first portion 302 is separated in another way, such as, but not limited to, removing the first portion 302 from a lanyard, or the like, that connects the first portion 302 and second portion 304, then the back side 308 is used only when the front side 306, is used and the back side 311 is used when the front side 310 is used.

Additionally, the tag 300 may also have an attached wristband with the same unique serial number. This can be used to provide a more secure and semi-permanent ID that travels with the person. It should be appreciated that the tag 300 can be connected or attached to the person using any suitable fastening device.

Besides the removable barcode 325 mentioned above, the tag 300 may be augmented with RFID technology allowing operators to read, or write to, the tag so that the victim or person's ID data or transactional data can travel with the victim. This application crosses-over with the assignee's U.S. Pat. No. 6,761,312. The machine-readable data printed on the tag 300 associated with the person may take many different forms. For example, and in no way limiting, the machine-readable data may be contained in a radio frequency (RF), infrared (IR) signal, or the like, and transmitted from a transmitter attached to the person, a medical apparatus, or device associated with the person, or may be stored electronically or magnetically, and retrieved using an appropriate external reading device. By way of explanation and not limitation, the tag 300 may include an RF or IR transmitter, smart card, smart button, RF identification chip, or the like. Typically, the machine-readable data is presented in the form of two-dimensional symbology, such as PDF417, in which the tag 300 includes a label having the machine-readable data printed on it.

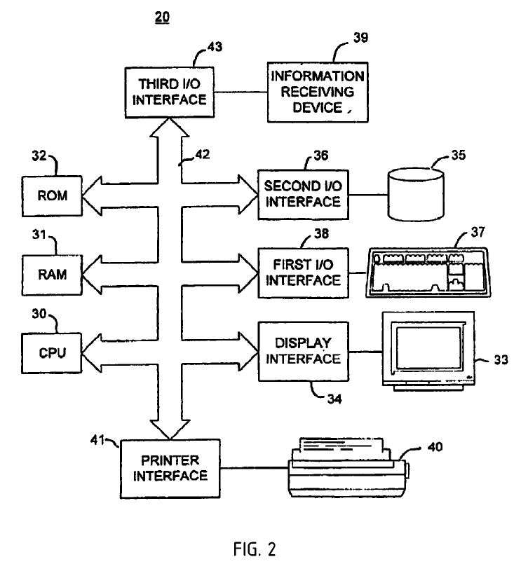

FIG. 2 shows an example of one external database or computer hardware system 20 that may be used, in whole or in part, to implement the various embodiments of the tracking system of the present invention. As shown in FIG. 2, computer hardware system 20 includes a central processing unit (CPU) 30; a random access memory (RAM) 31; a read only memory (ROM) 32; a display monitor 33; a display interface 34 connected to display monitor 33; a data storage device 35; a first input/output (I/O) interface 36 connected to data storage device 35; a keyboard 37; a second I/O interface 38 connected to keyboard 37; an information receiving device 39 connected to a third I/O interface 43; a printer 40; a printer interface 41 connected to printer 40; and a system bus 42 for interconnecting CPU 30, RAM 31, ROM 32, display interface 34, first I/O interface 36, second I/O interface 38, and printer interface 41. As described below, information receiver 39 may take any appropriate form for receiving data from the particular form of machine-readable data used for the particular embodiment, or for receiving machine-recognizable information that may be processed by a computer. Typically, the data storage device 35 is a computer hard disk drive or the like.

As will be apparent to those of ordinary skill in the art, the components of computer hardware system 20 may be incorporated into a personal computer or a portable laptop computer, with the possible exception of information receiver 39 and printer 40. However, as will become apparent from the following description of the present invention, certain components of computer hardware system 20 may be eliminated, depending upon the manner in which it is used within the confines of the present invention. For example, if computer hardware system 20 were used solely for producing and storing the data associated with the victim, information receiver 39 may be eliminated. On the other hand, if computer hardware system 20 were used solely for receiving data and displaying the received data, keyboard 37 may be eliminated and printer 40 would become optional, unless one wished to print out information displayed on display monitor 33. By eliminating keyboard 37 and/or printer 40, computer hardware system 20 may be implemented in a very portable, small integral device. Clearly, the particular form taken by computer hardware system 20 will depend upon the manner and environment in which the system is used. Further, computer system 20 may also be configured with a cellular telephone, a global positioning system (GPS), digital camera, facsimile machine, image scanner, fax/modem, or the like.

The system may also include a portable power source, such as a rechargeable battery, so that the system may receive power in the event of a local power failure, which may accompany such mass casualty events. As will be apparent, the transportability of the system and the data associated with the victims may be critical when the mass casualty event has caused power failures and break downs of the communication systems (telephone lines and towers and radio communication systems) that would otherwise be in place.

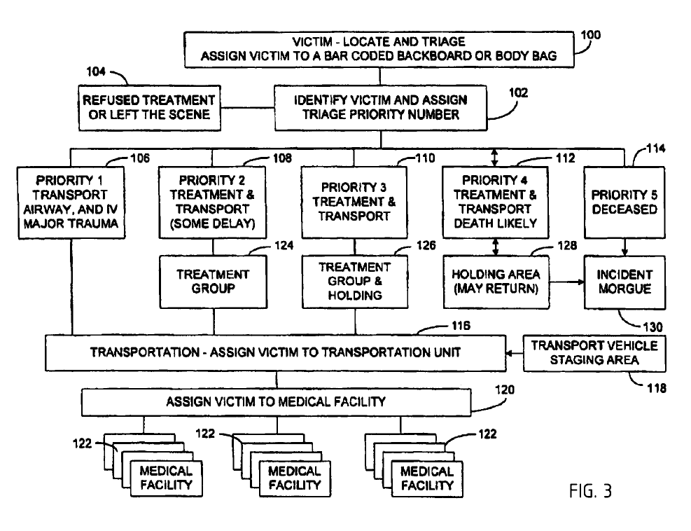

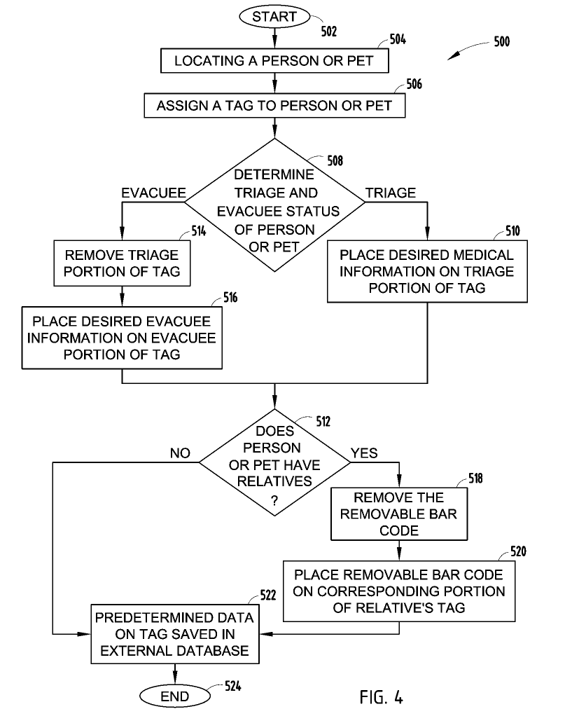

FIG. 3 illustrates but one example of how the present invention may be employed to process and track persons or victims of a mass casualty incident. The first step in treating victims of any mass casualty is to locate and triage the victims. As each victim is located, they are assigned to a backboard, gurney, bed, or body bag (block 100). Each person located is given a tag 300. Alternatively, each such backboard, gurney, bed, or body bag would typically include a pouch for maintaining a tag 300, or otherwise have the tag 300 affixed to this item. The tag 300 would typically be configured to carry one or removable barcodes 325 that may be printed and releasably secured to the tag 300. Each such tag 300 would include the removable barcode 325, or the like, which uniquely identifies the body bag, gurney, or backboard. Such unique identification allows for initial tracking of the victim assigned to that article.

As indicated in block 102, the next step is to attempt to identify the victim and assign a priority number. Some of the “victims” may refuse treatment or leave the scene, as indicated in block 104, in which case, they are not further processed. It should be noted that the primary purpose of the initial step is to assign a triage priority number, since the victims may be identified at subsequent steps. In particular, if the victim is in the most critical condition, it is important to get that victim to the nearest medical facility without delay.

In general, each victim is assigned one of five priorities indicated with reference to blocks 106 through 114. By way of explanation and not limitation, priority 1 (block 106) is reserved for the most critically injured and treatable victims; priority 2 (block 108) is reserved for victims that are somewhat less critical than priority 1 victims; priority 3 (block 110) is reserved for victims whose injuries are less than those of the priority 2 victims; priority 4 (block 112) is reserved for those victims whose injuries are so traumatic that death is imminent; and priority 5 (block 114) is reserved for victims who are deceased. Thus, when the victims are assigned a priority (block 102), the priority is either printed onto a label that may be secured to the tag of the backboard, gurney, or body bag with which the victim is associated, or tabs 312-320 of tag 300 may be removed to designate the priority, as discussed below. Because priority 1 victims should be immediately transported to the appropriate medical facility, these victims may, at the same time, be assigned to a transportation unit (block 116) and to a medical facility 122 (block 120). These assignments may be printed onto a barcode that is affixed to the tag 300 associated with the victim.

Priority 2 victims may be temporarily maintained and treated by a treatment group 124 prior to transportation at a transport vehicle staging area 118 where they are assigned to a transport unit (block 116), and subsequently or simultaneously assigned to a medical facility 122 (block 120). Similarly, priority 3 victims may be held at a treatment group (block 126) prior to release or transport to a medical facility. Thus, priority 3 victims would be treated in a manner very similar to priority 2 victims, with the exception that they may have to wait longer to be transported to a medical facility.

Priority 4 victims are maintained in a holding area (block 128) where they may receive painkillers or other treatment. If it is subsequently determined that the victim is not facing imminent death, the victim may be returned and reassigned a different priority for treatment. On the other hand, if the priority 4 victim should become deceased, and hence, a priority 5 victim, they are transported to the incident morgue (block 130). Any reassignment in priority would preferably be indicated in a new tag 300.

The barcodes for the priority number, transportation unit, and medical facility to which the victim may be assigned could be attached to the victim's associated tag 300, and could also provide additional information, such as the victim's physical characteristics, nature of injury, medical condition, initial treatment, data on samples (such as the victim's blood type, pulse, blood pressure, etc.), decontamination information, and the like, or similar information which is relevant to the identification, treatment, or disposition of the victim. This additional information could be added to the existing information or separately added at any stage in the processing of the victims. Additional data may include the identification of any hazardous material with which the victim may have come into contact. Such information could prove extremely valuable to the doctors at the medical facilities who ultimately treat these victims. By providing such information as portable data, this information may be transported with the victim and read either manually or using standard equipment by any of those needing the information. Those who would read the information need not have access to any shared database to gain access to the information maintained in the associated barcodes or other high capacity medium. Advantageously, desirable information about the person or victim is provided in those conditions where there are disruptions in communications between emergency service vehicles, ambulances, and medical facilities.

Once the victim has arrived at a medical facility, those facilities may apply additional barcode labels to assist each medical facility in tracking the patients. Additionally, further information about the victims/patients may be obtained, such as their medical history, blood type, and other conditions that may not have been obtained in the field.

By way of explanation and not limitation, using tag 300, the identification of victims and patients and the tracking of the same may be accomplished by the following steps:
1. Attach tag 300 to the patient via the attached lanyard (not shown);
2. Remove the wristband (not shown) from the back of tag 300 and place on the patient's wrist;
3. Remove the patient triage priority tabs 314-320, as required, to identify the appropriate patient priority level. (Remove blue tab 320 for Priority 3; blue and green tabs 320 and 318 for Priority 2; blue, green, and yellow tabs 320, 318, and 316 for Priority 1; and tabs 320, 318, 316, and 314 for Priority 0);
4. In the event the patient received decontamination, the Decon group should remove the “No Decon” yellow label 340 at the completion of decontamination procedures;
5. In the event a patient was exposed to a hazardous material, check the appropriate box 342 (Bio, Chem, Rad);
6. Complete patient demographics, evaluation, and treatment portions 344,346,348 on tag 300, as patient priority protocols and time allow; and
7. Record patient serial number (tag number) on the triage/treatment/transport (Decon) logs by removing the removable barcode 325 and affixing it to the log in the appropriate location.

Additionally, the recording and tracking of associated family members and pets may be accomplished in the following manner:
1. Each victim/patient/evacuee receives a triage/evacuee tag 300 with the appropriate information as to status and priority completed;
2. The actual recording and tracking is completed by removing a person's (or pet's) removable barcode 325 and placing it on the back of the associated person's triage/evacuee tag 300 in the appropriate region 332a-332j of area 330. An example would be:
a. Parent receives Tag # MT135;
b. Child receives Tag # MT867;
c. Remove the removable barcode 325 from the Parent tag (MT135) and place it on the back side 308,311 of the Child tag (MT867) on the square labeled “Parent” 332e,332j; and
d. Remove the removable barcode 325 from the Child tag (MT867) and place it on the back side 308,311 of the Parent tag (M4T135) on the square labeled “Child” 332a-332d.

This method thus “links” associated people (and any pets) to each other for tracking purposes.

The tag 300 provides the ability to track evacuees from an incident or event to a relocation center or address. The methods used are similar to the methodology of triage tracking discussed above. The following procedures may thus be used:
1. Peel away or remove the first portion or triage layer 302 and discard. This will expose the second layer or evacuee layer 304 of the tag 300;
2. Attach the tag 300 to the person via the attached lanyard (not shown);
3. Remove the wristband (not shown) from the back of the tag 300 and place on person's wrist;
4. Complete a Demographics portion 420 of the second portion 302 including:
   a. Origin;
   b. Assigned location (relocation center or address);
   c. Transport (self, Bus #, etc.); and
   d. Family (Yes, No, name, etc.);
5. Follow the “Recording associated family” procedures as required (described above); and
6. Record evacuee serial number (tag 300 number) on the transport logs by removing the removable barcode 325 and affixing it to the log in the appropriate location.

The back sides 308,311 of the tag 300 provide a standard location 348 to record the medical inoculation/vaccination of a patient or evacuee. To quickly record this information as part of the mobile patient/evacuee records, complete the following:
1. Remove the barcode peel-off sticker (not shown) from the administered vial;
2. Place the sticker on the back of the patients/evacuee tag in the area 348 labeled “Treatment”;
3. Record the time/date and person administering in the blank space 349 next to the “Treatment” box; and
4. Peel a patient's removable barcode 325 from their tag 300 and place it on the inoculation/vaccination log.

In reference to FIG. 5, a method for tracking people in a public health crisis according to another embodiment of the present invention is generally shown at 500. The method 500 begins at step 502 and proceeds to step 504 were the person, victim, or pet is located. Next, a tag 300 is assigned (attached by lanyard, wristband, or the like) to the person or pet at step 506. At decision step 508, it is determined if the triage information or the evacuee information of the person or pet will be placed on the tag 300. If it is determined that the triage information will be placed on the tag 300, then the method proceeds to step 510, where the desired medical or triage information is placed on the triage portion of the tag 300. Typically, the triage portion of the tag 300 is the first portion 302. At step 510, all or any portion of the triage information described as being placed on the first portion 302 above, is placed on the tag 300. Then the method 500 proceeds to decision step 512.

However, if it is determined that the evacuee information will be placed on the tag 300 at decision step 508, the method 500 proceeds to step 514. At step 514, the first portion 302 of the tag 300 is removed so that the second portion or evacuee portion 304 is accessible. Next, the desired evacuee information relating to the person or pet is placed on the evacuee portion of the tag 300, at step 516. At step 516, all or any portion of the evacuee information described above as being placed on the second portion 304 above, is placed on the tag 300.

Whether the triage information is placed on the tag 300 at step 510 or the evacuee information is placed on the tag 300 at step 516, the method 500 proceeds to decision step 512, where it is determined if the person has relatives. If the person or pet does have relatives, the method 500 proceeds to step 518, where the removable barcode 325 is removed from the person's or pet's tag 300. At step 520, the removable barcode 325 is placed on the corresponding portion of the relative's tag 300. The method 500 then proceeds to step 522.

If it is determined that the person does not have relatives at decision step 512, then the method 500 proceeds to step 522, where predetermined data, such as, but not limited to, relationship information, is stored in the external database. Thus, the stored predetermined data can be searched and cross-referenced, as described above. The method 500 ends at step 524.

It will be appreciated by those skilled in the art that different triage priority schemes may be used. For example, the number of priorities and definitions of the priorities may vary. It will also be appreciated that the broad methodology of the present invention may be applied regardless of the triage priority scheme that is used. It should further be appreciated that the above system and method of tracking a person can be used to track pets or animals in addition to people.

The above description is considered that of a preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims, as interpreted according to the principles of patent law, including the doctrine of equivalents.

What is claimed is:

1. A tracking system comprising:
a plurality of tags, wherein a single tag of said plurality of tags is associated with a person;
a first portion of said tag, wherein said first portion provides at least triage information;
a second portion of said tag, wherein said second portion provides at least evacuee information;
at least one removable barcode, wherein said removable barcode is placed on at least one other person's tag of said plurality of tags to indicate the relationship information between said person and said at least one other person; and
an external database, wherein at least one of said triage information, said evacuee information, and said relationship information are transmitted from said tag and stored in said external database.

2. The tracking system of claim 1, wherein at least one of said triage information, said evacuee information, and said relationship information are searchable in said external database.

3. The tracking system of claim 1 further comprising machine-readable data relating to at least one of said triage information, said evacuee information, and said relationship information.

4. The tracking system of claim 3 further comprising a transmitter in said tag, wherein said machine-readable data is transmitted to said external database by said transmitter.

5. The tracking system of claim 3 further comprising an external reading device, wherein said external reading device reads and transmits said machine-readable data to said external database.

6. The tracking system of claim 1, wherein said triage information is on a front side of said first portion, said evacuee information is on a front side of said second portion, and said relationship information is on a back side of at least one of said first and second portions, such that said back side is accessible when either said triage information or said evacuee information is present.

7. The tag of claim 1, wherein at least one of said first portion and said second portion comprise a plurality of tabs having a predetermined classification corresponding to at least one of said person's said medical condition and said evacuee information.

8. A tag associated with a person comprising:
a first portion including a plurality of areas for providing at least triage information pertaining to said person's medical condition;
a second portion including a plurality of areas for providing at least evacuee information pertaining to said person's evacuee status; and
at least one removable barcode in at least one of said plurality of areas, wherein said removable barcode is placed on at least one other person's said tag to indicate relationship information between said person and said at least one other person.

9. The tag of claim 8, wherein said first portion is removed from said second portion to access said evacuee information.

10. The tag of claim 8, wherein said triage information is on a front side of said first portion, said evacuee information is on a front side of said second portion, and said relationship information is on a back side of at least one of said first and second portions, such that said back side is accessible when either said triage information or said evacuee information is present.

11. The tag of claim 8, wherein at least one of said plurality of areas on at least one of said first portion and said second portion comprise a plurality of tabs having a predetermined classification corresponding to at least one of said person's said medical condition and said evacuee information.

12. The tag of claim 8 further comprising an external database, wherein a searchable serial number associated with said removable barcode is stored in said external database.

13. The tag of claim 8, wherein at least one of said plurality of areas on at least one of said first layer and said second layer comprise machine-readable data.

14. The tag of claim 13, wherein said machine-readable data is transmitted to said external database.

15. The tag of claim 8, wherein at least one of said plurality of areas on at least one of said first layer and said second layer comprise treatment information, physical characteristics, nature of an injury, hazardous material information, demographics, and decontamination information.

16. A method for tracking at least one of a person and a pet affected by a public health crisis, said method comprising the steps of:
locating at least one of a person and a pet;
assigning a tag to at least one of said person and said pet;
determining at least one of triage information, evacuee information, and relationship information of at least one of said person and said pet;
placing desired said triage information, said evacuee information, and said relationship information on said tag; and
storing at least a portion of said triage information, evacuee information, and relationship information in an external database.

17. The method of claim 16 further comprising the step of removing a removable barcode from at least one of said person's said tag and said pet's said tag and placing said removable barcode on another tag.

18. The method of claim 17 further comprising the step of cross-referencing and searching said relationship information from at least one of said person's said tag and said pet's said tag.

19. The method of claim 16 further comprising the step of providing machine-readable data on said tag, wherein said machine-readable data is transmitted to said external database.

20. The method of claim 19 further comprising the step of searching said external database based upon at least a portion of at least one of said person's and said pet's said triage information, evacuee information, and relationship information.
